(19) United States
(12) Patent Application Publication
(10) Pub. No.: US 2008/0002229 A1
(43) Pub. Date: Jan. 3, 2008

(54) Systems and method for saving memory on screen

(75) Inventor: Peter Johnston, San Mateo, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 11/728,241

(22) Filed: Mar. 23, 2007

Related U.S. Application Data
(63) Continuation-in-part of application No. 11/479,294, filed on Jun. 30, 2006.
Application No. 11/479,294 is a continuation-in-part of application No. 11/479,562, filed on Jun. 30, 2006.
Application No. 11/479,562 is a continuation-in-part of application No. 11/480,221, filed on Jun. 30, 2006.
Application No. 11/480,221 is a continuation-in-part of application No. 11/479,596, filed on Jun. 30, 2006.
Application No. 11/479,596 is a continuation-in-part of application No. 11/479,896, filed on Jun. 30, 2006.

(51) Int. Cl. H04N 1/40

(52) U.S. Cl. 358/3.23

(57) ABSTRACT

Systems in accordance with the presently claimed invention use input data to create an output pulse that is a fraction of the width of a pulse of a pixel clock. The fraction of the width of a pulse of the pixel clock can be used to create a fraction of a pixel. Justification data may also be used to justify the fraction of the pixel. The presently claimed invention maintains a static pixel justification lookup table that can be used to determine the justification for each pixel.

### CROSS REFERENCES TO RELATED APPLICATIONS

This application is a continuation in part of commonly-assigned, copending application Ser. No. 11/479,294 of Peter Johnston filed 30 Jun. 2006, entitled “Systems for Generating a Pulse Width Modulated Signal” (Attorney Docket No. 9546.0025-00); Ser. No. 11/479,562 of Peter Johnston filed 30 Jun. 2006, entitled “Method and Apparatus for Image Alignment” (Attorney Docket No. 9546.0026-00); Ser. No. 11/480,221 of Peter Johnston filed 30 Jun. 2006, entitled “Circuitry to Support Justification of PWM Pixels” (Attorney Docket No. 9546.0027-00); Ser. No. 11/479,596 of Peter Johnston filed 30 Jun. 2006, entitled “Systems and Methods for Processing Pixel Data for a Printer” (Attorney Docket No. 9546.0028-00); and Ser. No. 11/479,896 of Peter Johnston filed 30 Jun. 2006, entitled “Systems and Methods for Processing Pixel Data for a Printer” (Attorney Docket No. 9546.0029-00), all of which are herein incorporated by reference in their entirety.

### BACKGROUND

1. Field of Invention

This disclosure relates to generating improved print quality of multibit image data on a bitonal print apparatus and more particularly, to the use of separate look-up tables for generating pixel density and pixel position.

2. Description of Related Art

One of the limitations of providing greater resolution in current printer technology involves the width of electrical pulses that are used to generate data. Current printer technology produces pixels by providing a print engine with electrical pulses, where the size of the pixel is a function of the duration of the electrical pulse. Greater resolution for printed material can be obtained by providing data, for example sub-pixel data, at a higher frequency than the base frequency of the electrical pulses used by the print engine. By providing sub-pixel data at a higher frequency, the printer can print a fraction of a pixel instead of a whole pixel, obtaining higher resolution in the process.

In one technique, serial data is provided at a frequency higher than the base frequency of the print engine and uses the serial data of higher frequency to print one dot with a controlled grey-scale level. Providing this serial data, however, requires a pulse generation circuit with much higher resolution than the print engine resolution. Thus, if resolution of the printed material is to be increased by 16 times using the above method, then the serial data must be provided at a frequency 16 times the frequency of the print engine. Thus, if a print engine has a clock running at 30 MHz, then the serial data would need a clock running at 480 MHz. In many cases, this higher clock speed can be obtained only by using a cost-prohibitive integrated circuit (“IC”).

Another technique that is used to increase printer resolution involves the use of fixed delays to generate finely controlled pulse widths. One drawback of this approach is that it is not easy to obtain similar pixel modulation performance across a wide range of printer base resolution frequencies. For example, if the circuit is designed to generate 16 grey-scale levels with a base frequency of 1 MHz, the same circuit will only provide 8 grey-scale levels with a different printer of a base frequency of 30 MHz. Another drawback occurs because the delays are typically implemented with IC gate delays that tend to vary widely from IC to IC because of unavoidable process variations.

Each of these techniques requires increased memory to accommodate the additional data needed to produce the higher resolution pixel. For example, increasing the resolution by 16 times may require that the amount of data input into the printer be increased by, for example, eight times. Increasing the resolution by 16 times may also require that the printer performs 15 comparisons to determine the width of the pixel. Results of these 15 comparison may then be used to provide a 4-bit output to the pulse width modulation (“PWM”) circuit of the printer.

Additional data may be used to provide justification, such as right, left, and center justifications, for the higher resolution pixel. To provide left or right justification, one additional bit may be needed while providing left, right, or center justification may require two additional bits of information. For each additional input bit, however, the number of comparisons may be more than doubled. When increasing the resolution by 16 times, adding one additional bit to provide for left-right justification may increase the number of comparisons that need to be performed from 15 to 31. Adding two additional bits in the original system to provide for left-center-right justification may increase the number of comparisons that need to be made from 16 to 63. The memory within the printer may need to be increased to accommodate the increased number of comparisons performed when justifying a higher resolution pixel.

Accordingly, there is a need for a system and method for generating higher resolution printer images with justification data while providing for more efficient use of memory.

### SUMMARY

In accordance with the present invention, apparatuses, systems, and methods for generating improved print quality of multibit image data on a bitonal print apparatus are shown.

In some embodiments, an image forming apparatus may comprise a first look up table with pulse width modulation data for each pixel, a second look up table with position data corresponding to a pulse width modulation for each pixel, a processing component, wherein the processing device outputs a pulse width modulation signal according to the pulse width modulation data and the position data, and an image forming component, which receives the pulse width modulation signal and forms images in accordance with the pulse width modulation signal. The first look up table may contain at least three dimensions, and the second look up table may contain at least two dimensions. The second look up table may be static. The values for the pulse width modulation data in the first look up table may be monotonically increasing.

The image forming apparatus may further comprise a first storage device which stores the first look up table, and a second storage device which stores the second look up table. The processing component may access the first storage device and the second storage device in parallel. The second storage device may contain a plurality of second look up tables.

In some embodiments, a first electronic device may contain the first look up table, the second look up table, and the processing component, and a second electronic device may contain the image forming component.

In some embodiments, the position data in the second look up table may be a function, at least in part, of one or more of an image to be formed and the location of a pixel on the image forming component.

In some embodiments, an image forming system may comprise a first look up table with pulse width modulation data for each pixel, a second look up table with position data corresponding to a pulse width modulation for each pixel, a processing component, wherein the processing component outputs a pulse width modulation signal according to the pulse width modulation data and the position data, and an image forming component, which receives the pulse width modulation signal and forms images in accordance with the pulse width modulation signal. The values for the pulse width modulation data in the first look up table may be monotonically increasing. In some embodiments, the second look up table may be static.

In some embodiments of the image forming system, a first storage device may store the first look up table, and a second storage device may store the second look up table. The processing component may access the first storage device and the second storage device in parallel.

In some embodiments of the image forming system, the position data in the second look up table may be a function, at least in part, of one or more of an image to be formed and the location of a pixel on the image forming component.

In some embodiments, an image forming method may comprise accessing pulse width modulation data from a first look up table for each pixel, accessing position data corresponding to a pulse width modulation from a second look up table for each pixel, forming a pulse width modulation signal as a function of the pulse width modulation data and the position data, and forming an image in accordance with the pulse width modulation signal. Accessing pulse width modulation data and accessing position data may occur in parallel. The second look up table used by the image forming method may be static.

In some embodiments of the image forming method, the position data in the second look up table may be a function, at least in part, of one or more of an image to be formed and the position of a pixel to be formed on an image forming component using the pulse width modulation signal.

### BRIEF DESCRIPTION OF THE DRAWINGS

FIG. 1 shows a block diagram of an exemplary printer coupled to an exemplary computer.

FIG. 2 shows a block diagram of an exemplary screening module.

FIG. 3 shows a diagram of an exemplary representation of a look up table.

FIG. 4 shows an exemplary comparison of input data to the values in each field of a pulse width LUT.

FIG. 5 shows an diagram of an exemplary pulse width look up table with a pixel position look up table.

FIG. 6 shows an exemplary comparator and summing circuit.

### DETAILED DESCRIPTION

Reference will now be made in detail to one or more exemplary embodiments of the present invention as illustrated in the accompanying drawings. Wherever possible, the same reference numbers will be used throughout the drawings to refer to the same or like parts.

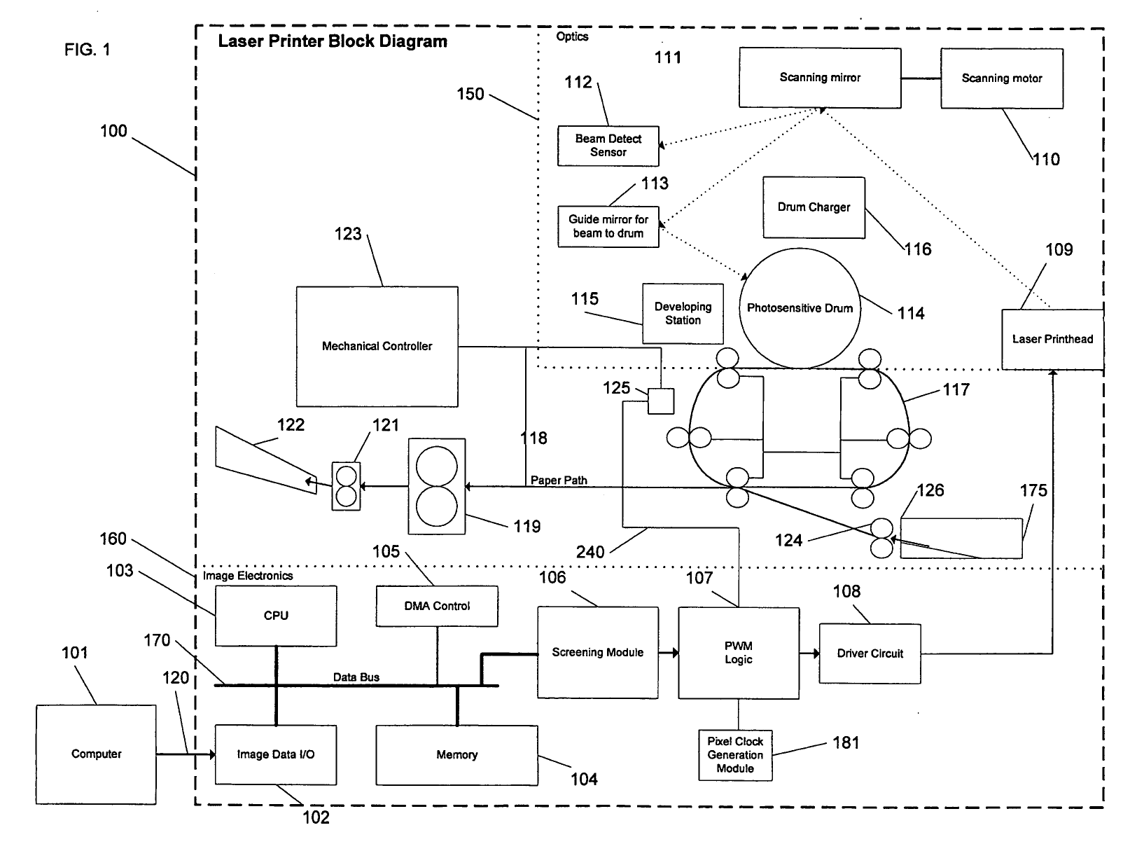

FIG. 1 is a block diagram of exemplary printer 100, which is coupled to exemplary computer 101. In some embodiments, printer 100 may be a laser printer, an LED printer, or any other printer consistent with principles of the present invention. Computer 101 may be a computer workstation, desktop computer, laptop computer, or any other computing device capable of being used with printer 100. Connection 120 couples computer 101 and printer 100 and may be implemented as a wired or wireless connection using conventional communication protocols and/or data port interfaces. In general, connection 120 can be any communication channel that allows transmission of data between the devices. In one embodiment, for example, the devices may be provided with conventional data ports, such as USB, FIREWIRE and/or serial or parallel ports for transmission of data through appropriate connection 120. The communication links could be wireless links or wired links or any combination consistent with embodiments of the present invention that allows communication between computing device 101, and printer 100.

In some embodiments, data received by printer 100 may be routed internally along internal data paths, such as exemplary data bus 170, and other data and control signal paths (not shown) to various internal functional modules of printer 100 as determined by control logic in printer 100. In some embodiments, data transmitted to printer 100 by computer 101 may also include destination addresses and/or commands to facilitate routing. In some embodiments, data bus 170 may include a subsystem that transfers data or power among modules. In some embodiments, data bus 170 may logically connect several modules over the same set of wires or over separate wires for each connection. In some embodiments, data bus 170 may be any physical arrangement that provides the same logical functionality as a parallel bus and may include both parallel and bit-serial connections. In some embodiments, data bus 170 may be wired in either an electrical parallel or daisy chain topology, or connected by switched hubs.

In some embodiments, image data input/output (“IO”) module 102, central processing unit (CPU) 103, direct memory access (DMA) control module 105, memory 104, and screening module 106, may be coupled using data bus 170. Data received by image data I/O module 102 may be placed in memory 104 using DMA control module 105 under the control of the CPU 103 according to some embodiments of the present invention. Screening module 106 may also be coupled to pulse width modulation (PWM) logic module 107. In some embodiments, screening module 106 may contain a decompressor sub-module that can receive compressed pixel data, decompress the received pixel data, and send it to PWM logic module 107. In some embodiments, a decompressor module may be separate from screening module 106.

Various data and control signal paths may couple PWM logic module 107, pixel clock generation module 181, driver circuit 108, printhead 109, mechanical controller 123, beam detect sensor 112 and transfer belt position sensor 125. In some embodiments, printhead 109 may be a laser printhead. In some embodiments, beam detect sensor 112 and/or belt position sensor 125 may each generate several signals for each scan line in an image, or for a set of scan lines in an image, or for each image and send the generated signals to mechanical controller 123, which then sends signals to PWM logic module 107.

Driver circuit 108 may be communicatively coupled to PWM logic module 107 and printhead 109. In some embodiments, scanning mirror 111 may be mechanically or electromagnetically coupled to scanning motor 110, which may be used to rotate scanning mirror 111. Light from printhead 109 may be transmitted to scanning mirror 111 and scanning mirror 111 may reflect that light, at different times, to beam detect sensor 112 and beam-to-drum guide mirror 113. Beam-to-drum guide mirror 113 may reflect light from scanning mirror 111 to photosensitive drum 114. Drum charger 116 may be used to charge photosensitive drum 114.

Paper 175 may be passed from paper input tray 126 through transfer rollers 124 to transfer belt 117 where latent images from photosensitive drum 114 may be transferred to paper 175. In some embodiments, latent images from photosensitive drum 114 may be developed with toner at developing station 115 before transfer to paper 175. The transfer of images from photosensitive drum 114 to paper 175 may occur while paper 175 is on transfer belt 117. After the image has been transferred, paper 175 may be moved over paper path 118 using transfer rollers 124 and past fuser 119, guide rollers 121, and to paper output tray 122. In some embodiments, fuser 119 may facilitate the bonding of the transferred image to paper 175.

Exemplary print engine 150 of printer 100 may include beam detect sensor 112, beam-to-drum guide mirror 113, developing station 115, photosensitive drum 114, drum charger 116, scanning mirror 111, scanning motor 110, and printhead 109. Exemplary image electronics subsystem 160 may include CPU 103, image data I/O module 102, memory 104, DMA control module 105, data bus 170, screening module 106, PWM logic module 107, and driver circuit 108. The various modules and subsystems described above may be implemented by hardware, software, or firmware or by various combinations thereof.

In some embodiments, computer 101 may send image data to image electronics subsystem 160 over connection 120. The image data sent from the computer 101 may be compressed. In some embodiments, the compressed image data may be in a line-sequential compressed format. Various other formats such as Postscript, PCL, and/or other public or proprietary page description languages may also be used to transfer image data. After image data is received by image data I/O module 102, the image data may be placed in memory 104 using DMA control module 105 under the control of CPU 103. In some embodiments, when image data for a complete page has been stored in memory 104, a print sequence may be initiated. In some embodiments, mechanical controller 123 may initiate operations of scanning motor 110, photosensitive drum 114, and transfer belt 117 through appropriate data and/or control signals.

Beam detect sensor 112 can detect a laser beam's position and generate pulses that are sent to image electronics subsystem 160 so that image data can be properly aligned from line to line in a printed image. In some embodiments, at the beginning of a scan of each line of the image, light from the printhead 109 may be reflected by scanning mirror 111 onto beam detect sensor 112. Beam detect sensor 112 may signal mechanical controller 123 which, in turn, may send a beam detect signal 240 to PWM logic module 107. In some embodiments, a separate signal typically referred to as top of data (TOD) or “vsync” may also be generated by mechanical controller 123, based on information received from transfer belt position sensor 125. The TOD or vsync signal indicates when image data transfer can begin for paper 175. For example, in some embodiments, a TOD signal may be sent to PWM logic module 107 via mechanical controller 123. Once the TOD signal is received, CPU 103 may initiate a transfer from memory 104 to decompressor module 106. In some embodiments, decompressor module 106 may decompress image data and pass the resulting raw image data to PWM logic module 107. The resultant PWM pulses from PWM logic module 107 may then be streamed to driver circuit 108, which may then transmit the PWM pulses to printhead 109.

In some embodiments, laser light from printhead 109 may be pulsed and reflected off scanning mirror 111 and beam-to-drum guide mirror 113, causing a latent image of charged and discharged areas to be built up on photosensitive drum 114. In some embodiments, toner develops this latent image at the developing station 115 and the latent image may be transferred to transfer belt 117. For a multi-component image, such as a color image, the latent image building process may repeat for each of the components. For example, for CMYK color printers, which use cyan (“C”), magenta (“M”), yellow (“Y”), and black (“K”), the latent image building process on photosensitive drum 114 may be repeated for each of the colors C, M, Y, and K. In some embodiments, when all components have been assembled on transfer belt 117, paper 175 may be fed from paper input tray 126 to transfer roller 124 where the image may be transferred to paper 175. In some embodiments, fuser 119 may then fix the toner to paper 175, which is sent to paper output tray 122 using guide rollers 121.

Pixel clock generation module 181 may be a crystal oscillator or a programmable clock oscillator, or any other appropriate clock generating device. In some embodiments, such as in a “multi-pass” printer 100, which sends the video data for each color serially in sequence, the frequency of the clock generated by the pixel clock generation module 181 may be fixed among each pass of the printer. In an example multi-pass printer 100, the pixel clock generation module 181 may be a crystal oscillator. In another embodiment, such as a printer 100 that uses multiple sets of print engines 150, sometimes collectively referred to as a “tandem engine”, the frequency of each channel may be calibrated if the frequencies differ among the pixel clocks corresponding to each of the color components. In such embodiments, one or more programmable clock oscillators may be used to allow for calibration.

Exemplary embodiments of printer 100 may include driver circuit 108 driving multiple sets of print engine 150, which may be connected to multiple printheads 109. In some embodiments, printheads 109 could all be laser printheads. There may also be a plurality of individual modules of image electronics subsystem 160. For example, a single screening module 106 may be connected to multiple PWM logic modules 107 with each PWM module 107 being connected to one or more pixel clock generation modules 181 and one or more driver circuits 108. Screening module 106 could provide each PWM logic module 107 with one or more color components of an image, which would then be sent to the multiple driver circuits 108 for onward transmission to one or more sets of print engine 150.

In other embodiments, multiple screening modules 106 may be coupled to multiple PWM logic modules 107. Each screening module 106 may provide a PWM logic module 107 with a decompressed component of the image. In other embodiments a single PWM logic module 107 could provide multiple components of the image to multiple driver circuits 108.

In some embodiments, printer 100 may have multiple lasers per laser printhead. In some embodiments, printhead 109 may receive multiple lines of data from driver circuit 108 and project the multiple lines of data to scanning mirror 111. Scanning mirror 111 may then reflect the multiple lines of data to beam detect sensor 112 and guide mirror 113, which may reflect the multiple lines to photosensitive drum 114. In some embodiments, the beam detect sensor 112 may detect a signal, such as a laser signal, reflected off of the scanning mirror 111, or may also detect multiple signals reflected off scanning mirror 111.

The coupling discussed herein may include, but is not limited to, electronic connections, coaxial cables, copper wire, and fiber optics, including the wires that comprise data bus 170. The coupling may also take the form of acoustic or light waves, such as lasers and those generated during radio-wave and infra-red data communications. Coupling may also be accomplished by communicating control information or data through one or more networks to other data devices. Mechanical or electro-mechanical coupling as used herein may include, but is not limited to, the use of physical components such as motors, gear coupling, use of universal joints, or any other mechanical or electro-mechanical device usable to couple items together.

Each of the logical or functional modules described above may comprise multiple modules. The modules may be implemented individually or their functions may be combined with the functions of other modules. Further, each of the modules may be implemented on individual components, or the modules may be implemented as a combination of components.

The logical or functional modules described above may be performed on one or more electronic devices. For example, a personal computer may implement functional modules such as (“IO”) module 102, central processing unit (CPU) 103, direct memory access (DMA) control module 105, memory 104, and screening module 106. The remaining functional modules may be implemented on one or more electronic devices, such as a printing device.

CPU 103, screening module 106, and PWM logic module 107 may each be implemented by a field-programmable gate array (FPGA), an application-specific integrated circuit (ASIC), a complex programmable logic device (CPLD), a printed circuit board (PCB), a combination of programmable logic components and programmable interconnects, single CPU chip, a CPU chip combined on a motherboard, a general purpose computer, or any other combination of devices or modules capable of performing the tasks of modules 103, 106 or 107. In some embodiments, memory 104 may comprise a random access memory (RAM), a read only memory (ROM), a programmable read-only memory (PROM), a field programmable read-only memory (FPROM), or other dynamic storage device, coupled to data bus 170 for storing information and instructions to be executed by image electronics subsystem 160.

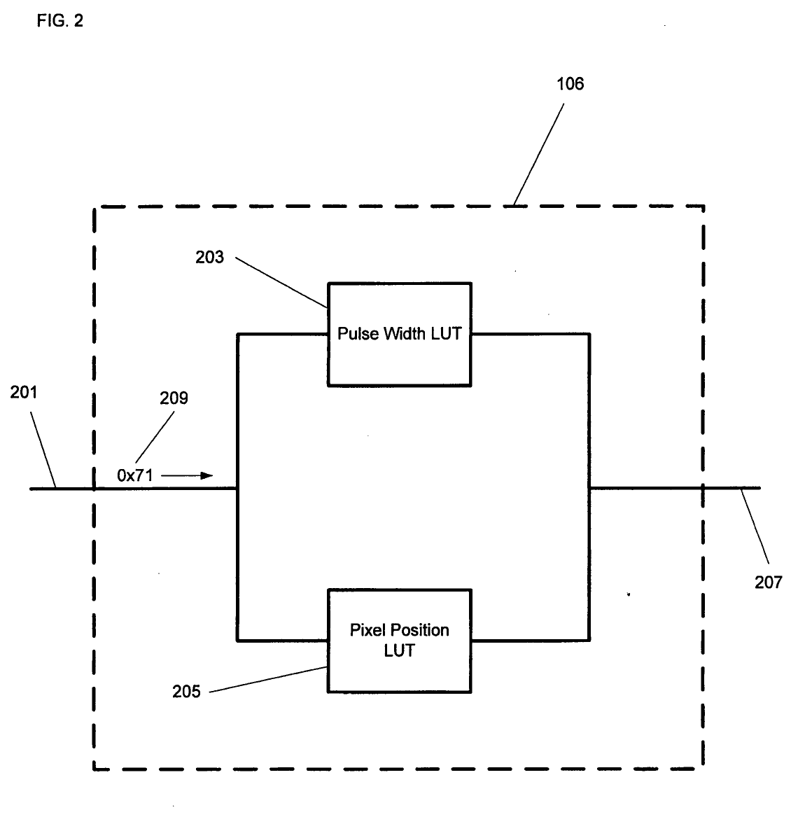

FIG. 2 shows a block diagram of an exemplary screening module 106 according to some embodiments of the present invention. Exemplary screening module 106 includes a pulse width look up table (“LUT”) 203 and a pixel position LUT 205. In some embodiments, screening module 106 may include a decompressor sub-module that can receive compressed pixel data, decompress the received pixel data, and output the decompressed pixel data. In some embodiments, decompressor module may be separate from screening module 106. The separate decompressor may receive compressed pixel data, decompress the received pixel data, and output the decompressed pixel data to screening module 106.

Screening module 106 may receive input data 209 on input connection 201. Input connection 201 may correspond to data bus 170, which may couple screening module 106 to one or more of computer 101, CPU 103, DMA control 105, and memory 104. Screening module 106 may receive input data 209 from one or more of image data IO module 102, CPU 103, DMA control module 105, and memory 104. Screening module 106 may receive input data 209 from modules other than image data IO module 102, CPU 103, DMA control module 105, and memory 104. In some embodiments, input data may be represented by a hexadecimal number. For example, as shown in FIG. 2, input data 209 may be represented by hexadecimal number 0x71. The two digit hexadecimal number may be input into screening module 106 as an eight bit binary number. Output from pulse width LUT 203 and pixel position LUT 205 is placed onto connection 207. Output connection 207 may be coupled to PWM module 107. PWM module 107 uses the output from screening module 106 to generate a pulse width modulated signal to drive the laser.

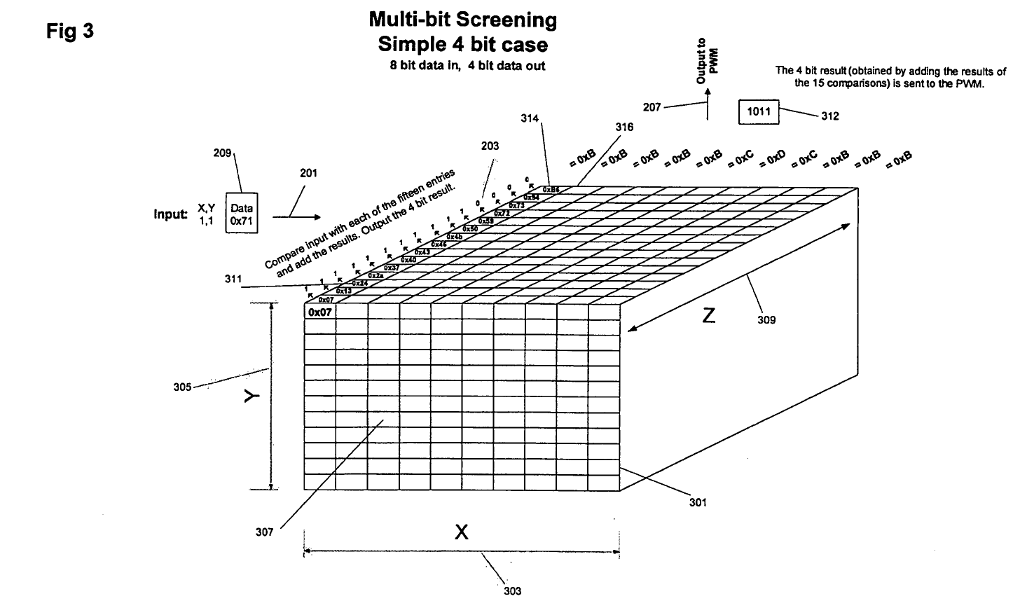

FIG. 3 shows a diagram of an exemplary representation of a pulse width LUT 203 for a each pixel on screen 301. Screen 301 represents the physical location of the pixels. Screen 301 may include x-axis 303 and y-axis 305. The location of a pixel may be described by using coordinates on x-axis 303 and y-axis 305. In some embodiments, the values for x-axis 303 and y-axis 305 may begin at the top left corner of screen 301. Thus, pixel 307 may have an x-coordinate of 3 and a y coordinate of 8.

As shown in FIG. 3, exemplary pulse width LUT 203 may include input connection 201 and output connection 207. Input data 209 may be delivered by input connection 201. In the exemplary embodiment shown in FIG. 3, input data 209 consists of the hexadecimal number 0x71, which may be input into pulse width LUT 203 using eight bits. Exemplary pulse width LUT 203 may then turn eight bit input data 209 into four bit output data 312. Output data 312 may be output onto connection 207 which may be coupled to PWM module 108, which may use the output to generate the modulated pulse width signal for driving the light in printhead 109.

Screen 301 may contain values for pulse width LUT 203 as shown, for example, in row 314. As shown in exemplary pulse width LUT 203 in FIG. 3, Z-axis 309 contains 15 fields for each pixel in screen 301. Each of the 15 fields for each pixel may contain values as shown in pulse width LUT 203 in row 314. In the embodiment shown in FIG. 3, the 15 fields of row 314 running along Z-axis 309 increase in value from 0x07 to 0xB6. The values in the fields of pulse width LUT 203 may be used to create output 312, which then may be used by PWM module 107 for generating a modulated pulse width signal.

The number of fields in pulse width LUT 203 may depend on a desired pulse width resolution for PWM module 107. The pulse width resolution of the output for PWM module 107 equals the smallest pulse interval possible in a specific configuration. Accordingly, the pulse width resolution of this embodiment shown in FIG. 3 may equal 1/16 th of the width of a pulse of the base pixel clock. Further, the frequency corresponding to this pulse width resolution is 16 times the frequency of the pixel clock of PWM module 107. Those skilled in the art will realize that other embodiments may have a frequency for the pulse width resolution that is greater or lesser than 16 times the frequency of the pixel clock.

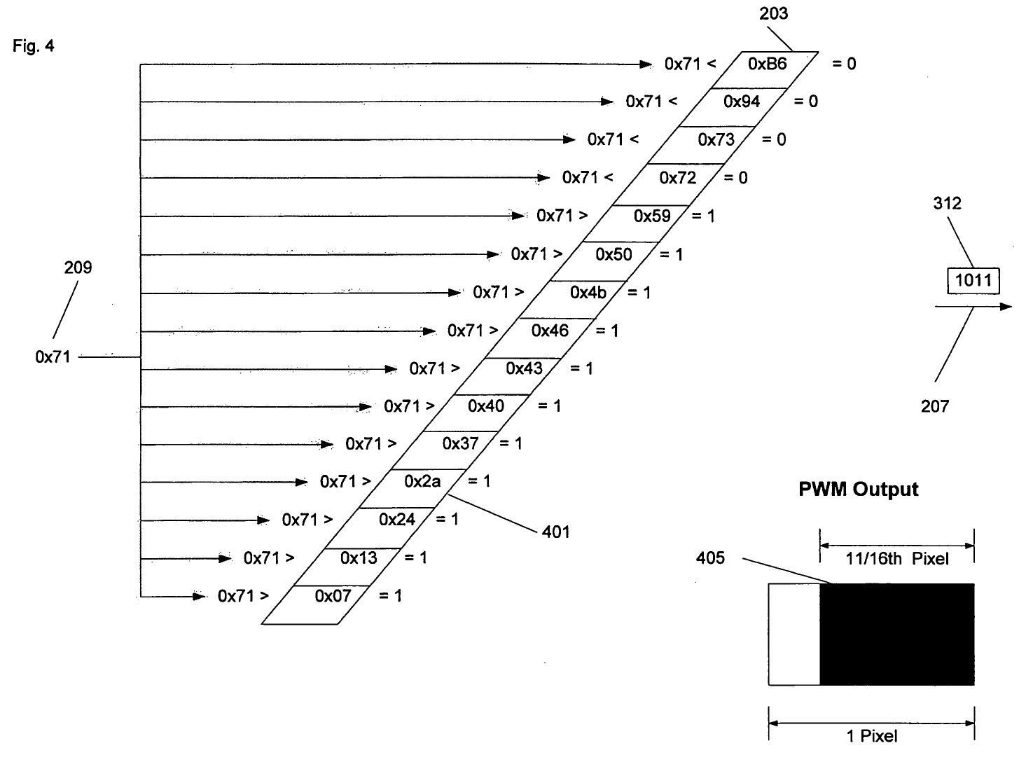

In some embodiments, output 312 may be calculated by comparing the value of input data 209 for a pixel to the values in each field of the pulse width LUT for that pixel. FIG. 4 shows an exemplary comparison of input data to the values in each field of a pulse width LUT. The values in the fields of pulse width LUT 203 may be monotonically increasing, as shown in FIG. 4. The values of the fields of pulse width LUT 203 may be monotonically decreasing. As shown in FIG. 4, the value 0x71 for input data 209 is compared to the values in each field of pulse width LUT 203. When the value of input data 209 is greater than the value in a field, then screening module 106 may associate a value of “1” with that field. Screening module may then sum all of the values associated with the fields of a pulse width LUT and may use that sum to generate output value 312. As shown in FIG. 4, input value 209 of 0x71 is greater than the values in the first eleven fields of pulse width LUT 203. As a result, output value 312 may correspond to a binary 11 (1011). Because the pulse width resolution in this embodiment may equal 1/16 th of the width of a base pixel clock pulse, output value 312 of 11 may result in a modulated pixel width of 11/16 ths of the base pixel clock pulse. The resulting output pixel 405 may be 11/16ths of the width of a full pixel.

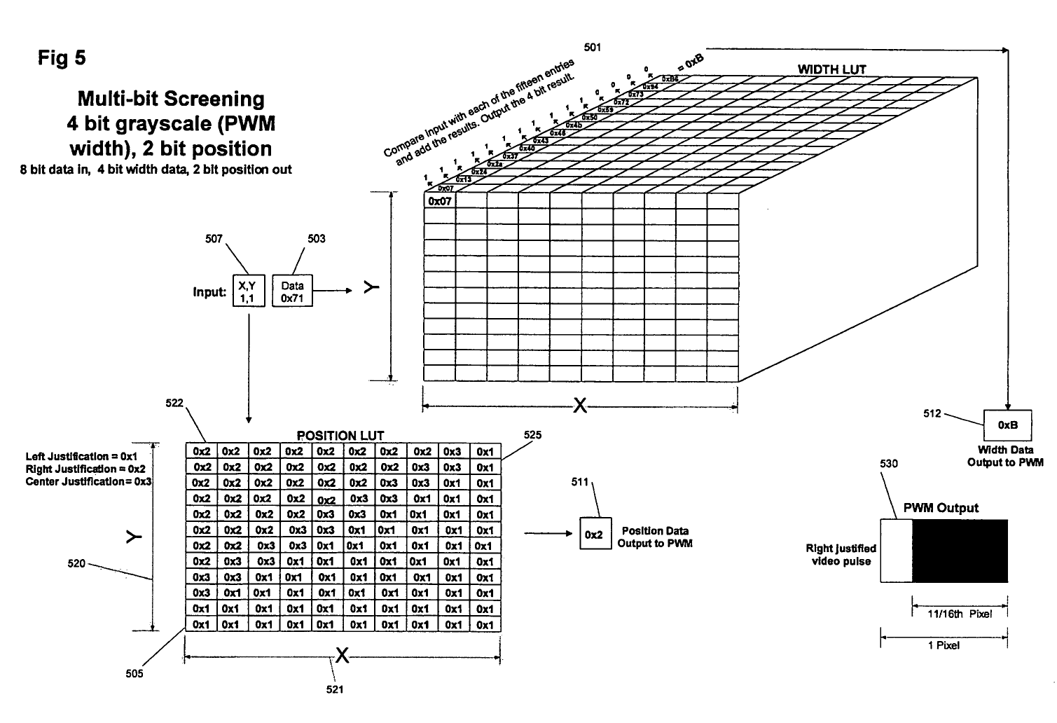

FIG. 5 shows a diagram of an exemplary pulse width LUT with a pixel position LUT. Exemplary pulse width LUT 501 may operate in the manner described above. Pixel position LUT 505 may be used to justify the resulting pixel. In the exemplary embodiment shown in FIG. 5, pixel position LUT 505 may be used to generate a two bit position output 511 to PWM module 107. Screen 525 represents the physical location of the pixels. Pixel positions may be determined using x-axis 521 and y-axis 520. In this embodiment, each axis may begin at the top left corner. Thus, exemplary Pixel 522 may be located at the coordinates 1, 1.

Values in pixel position LUT 505 may be used to determine a justification for the pixel generated at each coordinate on screen 525. As shown in the exemplary embodiment in FIG. 5, each pixel has associated with it a two bit value to signify left, right, or center justification. In this embodiment, the value 0x2 signifies right justification, 0x1 left justification, and 0x3 center justification. In this embodiment, pixel 522 may be right justified and have a value of 0x2. For example, pixel 530 has a length that is 11/16ths of the width of a full pixel and is right justified.

In some embodiments, the value for each field in pixel position LUT 505 may be determined and loaded into screening module 106 before any print commands are delivered to the printer. In some embodiments, the value for each field in pixel position LUT 505 may be static and may not change from one screen of data to another, different screen of data. In some embodiments, the characteristics of the data to be printed may need to be a design consideration when determining the justification values for each field in pixel position LUT 505. For example, design considerations may result in all pixels located in the middle of the screen being center justified, pixels located on the right side of the screen being left justified, and pixels located on the left side of the screen being right justified. As another example, design considerations may result in a diagonal strip of pixels being center justified, pixels on the left side of the diagonal strip being right justified, and pixels on the right side of the diagonal strip being left justified. Screening module 106 may contain one or more different pixel position LUTs 505.

In the exemplary embodiment shown in FIG. 5, position output 511 and width output 512 may be placed onto output connection 207 and sent to PWM module 107. PWM module 107 may receive position output 511 separately from width output 512. In some embodiments, screening module 106 may combine the two bit output from pixel position LUT 505 with the four bit output from pulse width LUT 501 before sending the output to PWM module 107. In some embodiments, PWM module 107 may receive the output from pixel position LUT 505 separately from the output of pulse width LUT 501. Other appropriate modifications may also be used and would be within the knowledge of one having ordinary skill in the art.

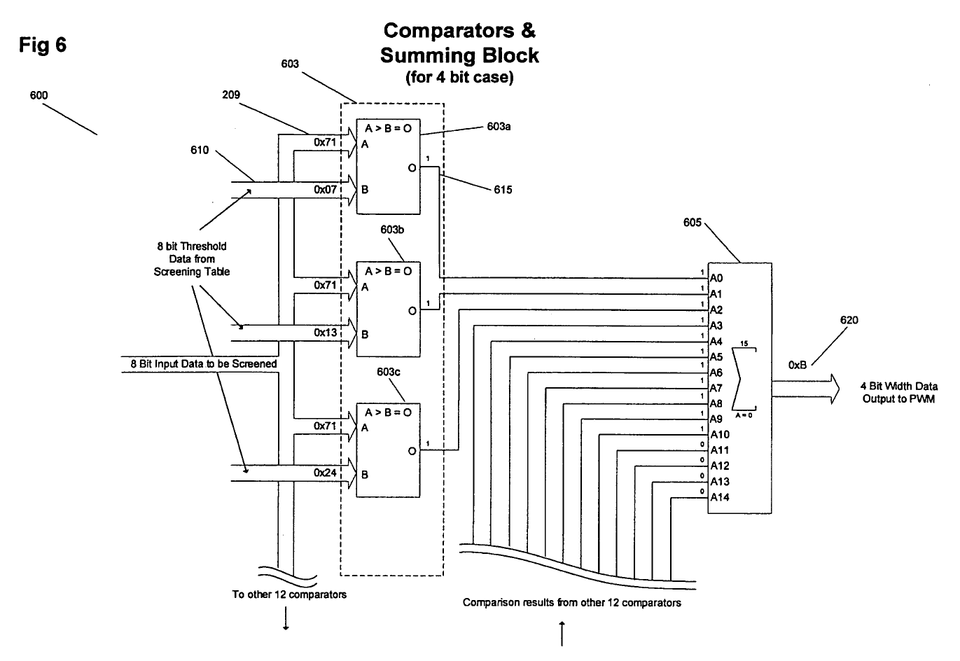

FIG. 6 shows an exemplary comparator and summing circuit. The exemplary comparator and summing circuit 600 may include comparator circuit 603 and summing circuit 605. Comparator circuit 600 may include one or more comparators, such as comparators 603a-603c. Each comparator in comparator circuit 600 may be coupled to summing circuit 605. Comparator circuit 600 may include more or less than three comparators. For example, comparator circuit 600 as shown in FIG. 6 may include 15 comparators. Comparators 603a-c may accept two inputs. For example, comparator 603a may accept as one input the value 0x71, which may correspond to input data 209 which is to be converted from eight bit input to a four bit output. Comparator 603a may accept value 0x07 as another input, which may correspond to comparison value 610. Comparison value 610 may be a value from pulse width LUT 501.

Comparators 603a-c may compare their respective inputs so that each may produce a corresponding output. For example, comparator 603a may compare input data 209 to comparison value 610. Comparator 603a may produce output 615 as a result of the comparison between input data 209 and comparison value 610. For example, as shown in FIG. 6, input data 209 (0x71) is bigger than comparison data (0x07). Comparator 603a may produce a 1 for output 615. Comparator 603a may produce a 0 as an output when input data 209 is less than comparison value 610. In some embodiments, comparator 603a may produce a 1 as an output when input data 209 is less than comparison value 610 and a zero as an output when input data 209 is greater than comparison value 610. When input data 209 equals comparison value 610, comparator 603a may produce either a one or a zero. In some embodiments, comparator 603a may sometimes produce a 1 and sometimes produce a 0 when comparison value 610 equals input data 209.

Each comparator in comparator circuit 603 may be coupled to summing circuit 605. Summing circuit 605 may be coupled to PWM module 107. Summing circuit 605 may sum the outputs from each comparator in comparator circuit 603. For example, summing circuit 605 as shown in FIG. 6 may sum the outputs from each of the 15 comparators in comparator circuit 603. In the exemplary circuit shown in FIG. 6, 11 comparators in comparator circuit 605 have produced a 1 output and four comparators in comparator circuit 605 have produced a zero output. Exemplary summing circuit 605 may produce output 620 as a function of the inputs to summing circuit 605. For example, summing circuit 605 may produce the hexadecimal value 0xB as output 620.

Other embodiments of the invention will be apparent to those skilled in the art from consideration of the specification and practice of the embodiments of the invention disclosed herein. It is intended that the specification and examples be considered as exemplary only, with a true scope and spirit of the invention being indicated by the following claims. As such, the invention is limited only by the following claims.

What is claimed is:

1. An image forming apparatus, comprising:
a first look up table with pulse width modulation data for each pixel;
a second look up table with position data corresponding to a pulse width modulation for each pixel;
a processing component, wherein the processing component outputs a pulse width modulation signal according to the pulse width modulation data and the position data; and
an image forming component, which receives the pulse width modulation signal and forms images in accordance with the pulse width modulation signal.

2. The image forming apparatus of claim 1 further comprising:
a first storage device which stores the first look up table; and
a second storage device which stores the second look up table.

3. The image forming apparatus of claim 2, wherein the processing component accesses the first storage device and the second storage device in parallel.

4. The image forming apparatus of claim 1, wherein a first electronic device contains the first look up table, the second look up table, and the processing component and wherein a second electronic device contains the image forming component.

5. The image forming apparatus of claim 1, wherein the second look up table is static.

6. The image forming apparatus of claim 1, wherein the values for the pulse width modulation data in the first look up table are monotonically increasing.

7. The image forming apparatus of claim 1, wherein the position data in the second look up table is a function, at least in part, of one or more of an image to be formed and a location of a pixel on the image forming component.

8. The image forming apparatus of claim 2, wherein the second storage device stores a plurality of two-dimensional look up tables.

9. The image forming apparatus of claim 1, wherein the first look up table contains at least three dimensions.

10. The image forming apparatus of claim 1, wherein the second look up table contains at least two dimensions.

11. An image forming system, comprising:
a first look up table with pulse width modulation data for each pixel;
a second look up table with position data corresponding to a pulse width modulation for each pixel;
a processing component, wherein the processing component outputs a pulse width modulation signal according to the pulse width modulation data and the position data; and
an image forming component, which receives the pulse width modulation signal and forms images in accordance with the pulse width modulation signal.

12. The image forming system of claim 11 further comprising:
a first storage device which stores the first look up table; and
a second storage device which stores the second look up table.

13. The image forming system of claim 12, wherein the processing component accesses the first storage device and the second storage device in parallel.

14. The image forming system of claim 11, wherein the second look up table is static.

15. The image forming system of claim 11, wherein the values for the pulse width modulation data in the first look up table are monotonically increasing.

16. The image forming system of claim 11, wherein the position data in the second look up table is a function, at least in part, of one or more of an image to be formed and a location of a pixel on the image forming component.

17. An image forming method, comprising:
accessing pulse width modulation data from a first look up table for each pixel;
accessing position data corresponding to a pulse width modulation from a second look up table for each pixel;
forming a pulse width modulation signal as a function of the pulse width modulation data and the position data; and
forming an image in accordance with the pulse width modulation signal.

18. The image forming method of claim 17, wherein accessing pulse width modulation data and accessing position data occur in parallel.

19. The image forming system of claim 17, wherein the second look up table is static.

20. The image forming method of claim 17, wherein the position data in the second look up table is a function, at least in part, of one or more of an image to be formed and a location of a pixel on an image forming component.
